(19) United States
(12) Patent Application Publication
(10) Pub. No.: US 2023/0387543 A1
(43) Pub. Date: Nov. 30, 2023

(54) BATTERY CELL ARRANGEMENT HAVING A POTTING COMPOUND LAYER, AND METHOD FOR PRODUCING A BATTERY CELL ARRANGEMENT FOR A MOTOR VEHICLE

(71) Applicant: AUDI AG, Ingolstadt (DE)

(72) Inventors: Michael KORTE, Ingolstadt (DE); Oliver SCHIELER, Gaimersheim (DE); Martin SIMON, Reichertshofen (DE)

(21) Appl. No.: 18/299,240

(22) Filed: Apr. 12, 2023

(30) Foreign Application Priority Data
May 30, 2022 (DE) 102022113602.7

(51) Int. Cl. H01M 50/358; H01M 10/625; H01M 10/653

(52) U.S. Cl. CPC H01M 50/358; H01M 10/625; H01M 10/653; H01M 2220/20

(57) ABSTRACT

A battery cell arrangement for a motor vehicle, having multiple battery cells, which each include two cell poles, a first side, a second side, a height in the direction from the second side to the first side, and a releasable degassing opening for discharging gases from the relevant battery cell in case of a thermal runaway. In case of a thermal runaway, a respective battery cell includes at least one thermal hotspot area, which is provided by at least one of the cell poles and/or the degassing opening, and the battery cell arrangement includes at least one potting compound layer, in which a section of a respective battery cell is embedded in the direction of the height.

### FIELD

The invention relates to a battery cell arrangement for a motor vehicle, which includes multiple battery cells, each of which in turn includes two cell poles, a first side, a second side opposite to the first side, a height in the direction from the second side to the first side, and a releasable degassing opening for discharging gases from the relevant battery cell in case of a thermal runaway of the battery cell. Furthermore, in case of a thermal runaway, a respective battery cell includes at least one thermal hotspot area, which is provided by at least one of the cell poles and/or the degassing opening. Furthermore, the battery cell arrangement includes at least one potting compound layer, in which a section of a respective battery cell is embedded in the direction of the height. The invention furthermore also relates to a method for producing a battery cell arrangement.

### BACKGROUND

Potting compounds are used in battery systems to fulfill various functions. For example, it can be used for fluidic sealing of a cooling chamber in order to allow coolant to flow directly around the battery cells, as described in DE 10 2014 106 852 A1, for example. The cell poles protrude from the potting compound, so that the potting compound separates the cell poles from the cooling chamber.

A further possible application is the use to attach the cells to a heat sink, as described in WO 2020/053251 A1. In this case, a venting channel is provided in the potting compound for discharging gases from a damaged battery cell. The potting compound is to be as thermally conductive as possible in order to be able to dissipate heat from the cells to the heat sink as efficiently as possible. However, the venting channels provided in the potting compound impair the heat dissipation since they increase the thermal resistance between the cells and the heat sink. In addition, this requires more installation space, since a greater distance between the battery cells and the heat sink is required to introduce or provide the venting channels. The increased distance also in turn has a negative effect on heat dissipation.

It is also possible to embed the battery cells completely in such a potting compound. However, this in turn has a negative effect on the overall weight of the battery. Above all, however, a thermal coupling of the battery cells with one another is disadvantageous, in particular in case of damage, since the heat that develops in a damaged battery cell can thus propagate very quickly and can spread to other cells.

Furthermore, DE 10 2020 113 951 B3 describes a battery module having multiple battery cells and a cooling device and a cavity between the cooling device and a lower side of each battery cell, which is filled by a thermally conductive and electrically insulating potting compound. A second cavity, which encloses a lateral surface of each of the battery cells, is filled by a thermally insulating second potting compound, and a third cavity, which encloses an upper side having two electrical connections of each battery cell and a respective cell connector arranged thereon, is filled by a third potting compound. Different properties are to be implemented by the different potting compounds. The first potting compound is to be as thermally conductive as possible, while the second potting compound is to be as thermally insulating as possible, and the third potting compound is to provide a supporting structure. The cells are also ultimately completely encased in potting compound here, which in turn has a negative effect on the overall weight of the battery.

### SUMMARY

The object of the present invention is to provide a battery cell arrangement and a method that make it possible to ensure the greatest possible safety of such a battery cell arrangement in the simplest and most efficient manner possible, especially in case of a thermal runaway of a battery cell.

A battery cell arrangement according to the invention for a motor vehicle includes multiple battery cells, each of which includes two cell poles, a first side, a second side opposite to the first side, a height in the direction from the second side to the first side, and a releasable degassing opening for discharging gases from the relevant battery cell in case of a thermal runaway of the battery cell. Furthermore, in case of a thermal runaway, a respective battery cell includes at least one thermal hotspot area, which is provided by at least one of the cell poles and/or the degassing opening. Furthermore, the battery cell arrangement includes at least one potting compound layer, in which a section of a respective battery cell is embedded in the direction of the height. In this case, the at least one thermal hotspot area is embedded in the potting compound layer, which is formed by a potting compound for thermally shielding the battery cells from one another in case of a thermal runaway.

The invention is based on the finding that thermal decoupling of battery cells from one another by means of a potting compound for thermal shielding of the battery cells can be implemented particularly efficiently if at least one thermal hotspot area of the battery cells, which is thus provided by the cell poles and/or the degassing opening of the relevant battery cell, is embedded in this potting compound. In case of a thermal runaway of a battery cell, it is precisely from such hotspot areas that a very large amount of heat is developed. Due to the embedding in a potting compound for thermal shielding, which is accordingly designed with the lowest possible thermal conductivity, the spread of this heat development to neighboring cells can be suppressed or at least delayed in a particularly efficient manner. This in turn makes it possible to prevent or at least also delay a thermal runaway of the entire battery cell arrangement. Even worse consequences, such as a battery fire, can accordingly also be prevented or at least delayed. The safety in case of a thermal runaway of at least one of the battery cells can thus advantageously be significantly increased in a simple and efficient manner by the at least one potting compound layer.

A thermal hotspot area is characterized in that the temperature of the relevant battery cell is higher in this hotspot area than in a local environment of this hotspot area in case of a thermal runaway of this battery cell. In other words, a hotspot area represents an area of the battery cell which, in case of a thermal runaway of this cell, has a local temperature maximum, which, however, does not necessarily have to represent the hottest area of the cell or the cell outside. However, it is conceivable that the releasable degassing opening and the two cell poles of a respective cell represent the three hottest hotspot areas of the cell outside. In addition, the hotspot area does not have to be restricted to this local temperature maximum, but can comprise a small, spatially extended area around this temperature maximum. Above all, the cell poles and the releasable degassing opening typically represent such hotspot areas of a battery cell in case of a thermal runaway. Accordingly, it is very advantageous to embed the cell poles and/or the degassing opening of the battery cell in the potting compound as hotspot areas. Furthermore, it is preferred that no thermal connection to a heat sink or a cooling plate or a cooling base or the like is implemented via the potting compound layer. A different potting compound layer having different thermal properties or an adhesive layer or the like can be used for this purpose, for example. As a result, it is advantageously possible to optimize the potting compound layer with respect to its property for thermally shielding the battery cells from one another, without reducing the heat dissipation efficiency during normal operation.

The releasable degassing opening of a respective battery cell can be provided, for example, by a predetermined breaking point in a cell housing of the relevant battery cell. This can be implemented, for example, by a thin bursting membrane or the like. In case of a thermal runaway of a battery cell, gases are produced inside the battery cell, which, if the pressure is sufficiently high, accordingly result in the releasable degassing opening due to the internal cell pressure, as a result of which the gases can escape from the relevant cell that is running away. Such gases also comprise larger particles that are entrained in the gas flow. As will be described later in more detail, it is also not necessary for degassing channels or the like to be introduced into the potting compound layer. The potting compound layer, in particular if the at least one releasable degassing opening is embedded therein as a hotspot area, can simply be made correspondingly thin at this point, so that the potting compound layer is simply so to speak penetrated or shot through at this point by the gas flow exiting from the cell.

A further advantage of using such a potting compound layer is that it can then simultaneously assume the function of spacers between the cells. This is particularly advantageous if the battery cells are designed as round cells, in the case of which such spacers or spacer grids are often used. Additional components can thus also be saved. In addition, the potting compound layer is preferably designed such that it only extends over a section of a respective battery cell in the direction of the height of the relevant battery cell, but not over the entire height of the battery cells. Consequently, the relevant battery cells are not completely embedded in the potting compound layer. The section preferably extends over at most half the height of the battery cells, particularly preferably over significantly less than half. This reduces the overall weight of the battery cell arrangement. In principle, it is also possible for multiple such potting compound layers to be provided, which extend over a respective section of a respective battery cell in the direction of height. Is also then preferred in this case that the battery cells are not completely embedded in such potting compound layers. In other words, at least one section of a respective battery cell is provided, which is not embedded in a potting compound layer, and this extends in particular over at least half the height of the battery cells or, in the case of multiple free sections, these extend in total over at least half the height of the battery cells.

It is also very advantageous if only a single such potting compound layer is provided, at least for the purpose of thermally shielding the battery cells. Not only one thermal hotspot area, but in particular also multiple thermal hotspot areas of the cell can be embedded therein at the same time, for example both the cell poles and the at least one degassing opening. As a result, the battery cell arrangement can be provided in a particularly cost-effective and efficient manner. This is then also particularly easy to implement in terms of manufacturing technology.

The battery cells can generally be prismatic battery cells, pouch cells, or round cells. The use with round cells is particularly advantageous, since these can often includes cell poles and a releasable degassing opening on the same side of the battery cell, or this can be implemented in a particularly simple manner with round cells. As a result, all hotspot areas can be embedded in a common potting compound layer in a particularly simple and efficient manner. Nevertheless, the application with prismatic battery cells or pouch cells is implementable advantageously in the same way. Moreover, the battery cells can be formed, for example, as lithium-ion cells. For example, a traction battery for a motor vehicle can be provided by the battery cell arrangement, for example a high-voltage battery or also only one battery module for such a high-voltage battery.

One of the two cell poles of a cell is designed as a positive pole and the other as a negative pole. The cell poles can be interconnected or can each be contacted with an electrically conductive contact element for the purpose of interconnection, for example a cell connector or module connector or the like. Such contact elements can also be embedded in the potting compound if the hotspot area embedded in the potting compound represents one of the cell poles. However, it is also conceivable that such contact elements are not embedded or are only partially embedded in the potting compound. However, the thermal decoupling can be further increased by embedding, so that it is preferable to also embed these contact elements accordingly.

By embedding the contact elements, it is also possible to protect them from contact with the gas escaping from the damaged battery cell. This reduces the probability of arcing within the battery.

In a further very advantageous embodiment of the invention, the potting compound is designed to be electrically and/or thermally insulating. It is preferably designed to be both electrically insulating and, if possible, thermally insulating. For example, a thermal conductivity of less than 1 watt per meter and per Kelvin can be provided by means of the potting compound. Furthermore, it is advantageous if the potting compound is designed in such a way that it is non-flammable and/or fire-retardant and/or non-combustible, in particular also for temperatures of several hundred degrees Celsius. Therefore no additional risk of fire results from the provision of the potting compound, even in case of a thermal runaway of a battery cell. It is also conceivable that the potting compound is designed in such a way that it changes its material properties at very high temperatures, in particular when one or more limiting temperatures are exceeded. For example, it can be that the thermal conductivity of the potting compound decreases when such a limiting temperature is exceeded. The potting compound can thus be designed, for example, in such a way that its thermally insulating properties only occur when such a limiting temperature is exceeded.

In a further very advantageous embodiment of the invention, the potting compound ceramizes from a predetermined temperature, in particular above 100° C., and in particular comprises ceramic particles embedded in a matrix. Ceramics in particular are very dimensionally stable and have good thermal insulation properties. Correspondingly, it is very advantageous if the potting compound ceramizes above a specific limiting temperature, i.e., the potting compound becomes a ceramic, and in particular the potting compound layer becomes a quasi-ceramic plate. Such a ceramic plate is particularly heat-resistant and is therefore very well suited for thermally shielding the cells from one another.

This embodiment of the invention is based on the one hand on the knowledge that ceramics have very good fire protection properties, which is why such a potting compound that converts to ceramic when overheated is outstandingly suited to simultaneously assume a fire protection function in a battery. In addition, the invention is based on the finding that materials can be synthesized into a ceramic when overheated, so that in case of a thermal runaway of a battery cell, the potting compound layer automatically becomes a ceramic at least locally or also globally due to the resulting overheating and thus develops its flame-retardant properties.

Accordingly, it is provided in an advantageous embodiment of the invention that the thermal interface material includes a matrix and a filler, wherein the matrix at least in large part includes a silicone, and the filler at least in large part comprises ceramic particles. Furthermore, it can be provided that exclusively ceramic fillers, i.e., the ceramic particles mentioned, are used as fillers. Aluminum oxide, in particular certain modifications thereof, hydroxides, or the like come into consideration as such ceramic particles. Above all, it is particularly advantageous if the matrix is provided by a silicone at the same time. This in turn is based on the finding that using a silicone as a matrix makes it possible to synthesize the fillers and the matrix to form a ceramic plate when the specific temperature is exceeded. When the specific temperature is exceeded, the silicone in the silicone matrix turns into silicon oxide, which also provides a ceramic compound which, in combination with the other ceramic particles, ultimately forms a solid ceramic plate. In other words, when the thermal interface material is overheated, a ceramic material is formed, which can be porous but is solid and is equipped with very good fire protection properties.

In a further very advantageous embodiment of the invention, the at least one hotspot area comprises the releasable degassing opening of a respective battery cell. Precisely the area in which such a releasable degassing opening of a respective battery cell is arranged heats up extremely strongly in case of a thermal runaway of the relevant battery cell. It is therefore very advantageous to embed precisely this area, that is to say a respective releasable degassing opening of the battery cells, in the potting compound layer. As a result, a particularly efficient thermal decoupling of the battery cells from one another can be provided.

In a further very advantageous embodiment of the invention, the releasable degassing opening is arranged on the first side of a respective battery cell, wherein the first side is embedded in the potting compound layer, in particular wherein the second side of a respective battery cell faces toward a carrier, in particular a cooling base, on which the battery cells are arranged. In other words, in this configuration the potting compound layer is located on a side of the battery cells opposite to such a carrier. The battery cells can be attached to the carrier, in particular if it is designed as a cooling base, via a further potting compound layer or adhesive layer. This further potting compound layer or adhesive layer is then preferably designed in such a way that it has the best possible thermally conductive properties. In contrast, the potting compound layer on the first side of the respective battery cell can provide very good thermal decoupling of the battery cells from one another. The remaining intermediate spaces between the cells can represent free spaces, which are therefore not filled using a potting compound. As a result, the overall weight of the battery cell arrangement can be reduced. If the battery cells are designed as round cells, for example, the first and the second side of a respective battery cell preferably represent the end faces of the battery cells. The end faces of round cells are typically formed circular. Independently of the geometry of the battery cells, they are thus embedded in the potting compound layer with one end facing away from the carrier on which the battery cells are arranged. This is particularly easy to implement in terms of manufacturing technology and enables particularly good thermal decoupling. In addition, this also has the great advantage, which will be explained in more detail below, that a particularly suitable gas discharge of the gas escaping from the damaged battery cell can be provided in this way.

It therefore represents a further very advantageous embodiment of the invention if the releasable degassing opening of a respective battery cell is embedded in the potting compound layer in such a way that in case of a thermal runaway of the relevant battery cell, a potting compound area of the potting compound layer covering the releasable degassing opening is penetrated by the gas escaping from the associated degassing opening gas. This has the great advantage that no gas discharge channels or the like have to be integrated into the potting compound layer itself. This simplifies production enormously and also saves installation space. In addition, this allows the gas to be conducted to the side of the potting compound layer facing away from the battery cells. The potting compound layer thus additionally also functions as a thermal insulating layer between the gas to be discharged and the battery cells. The escaping gas therefore cannot heat the battery cells, in particular further battery cells of the battery cell arrangement arranged adjacent to the damaged battery cell, or at least not as much and as quickly. In order that the potting compound layer can also be penetrated by the escaping gas, it is preferably made as thin as possible, particularly in the area of the releasable degassing openings. In this area, the layer can have a thickness of at most a few millimeters in a defined first direction, which is defined by the direction of the height of a respective battery cell. The height of a respective battery cell is defined from the second to the first side of the relevant battery cell. In areas between the battery cells, the potting compound layer has a greater layer thickness.

In a further very advantageous embodiment of the invention, a degassing channel for discharging the gas penetrating the potting compound area is arranged on a side of the potting compound layer facing away from the battery cells, in particular wherein the degassing channel adjoins the potting compound layer. The potting compound layer thus advantageously functions at the same time as a thermal insulation layer between the degassing channel, which is used to discharge gas from the battery cell arrangement, in particular from the battery and the motor vehicle, and the battery cells.

The degassing channel can be delimited, for example, on the one hand by the potting compound layer and on the other hand by further structural devices of the battery cell arrangement, for example a cover of a battery housing or the like, which form further channel walls of such a degassing channel. The battery cell arrangement can therefore also include a battery housing in which the battery cells are arranged. A housing side of this battery housing can be provided, for example, by the above-mentioned carrier, which, for example, can be designed at the same time as a cooling device. This carrier can represent a cooling base, for example, which at the same time provides a base for the battery housing. For the gas discharge from the battery housing, the battery housing can include an opening or a releasable opening, through which the gas flowing along the degassing channel can be guided out of the battery housing. The potting compound layer can be designed in such a way that it divides the space inside the battery housing into two sub-spaces, wherein the degassing channel is arranged in one of the two sub-spaces or wherein one of the two sub-spaces functions as a whole as part of the degassing channel, while the sections of the battery cells that are not embedded in the potting compound itself are arranged in the other of the two sub-spaces. The two sub-spaces are therefore fluidically separated from one another by the potting compound layer, as a result of which the battery cells are particularly well protected from the gas flow flowing through the degassing channel.

According to a further very advantageous embodiment of the invention, at least one of the cell poles, preferably both of the cell poles, is embedded in the potting compound layer as the at least one hotspot area. This embodiment is combinable in particular with the above-mentioned embodiments, according to which the releasable degassing opening of each cell is embedded in the potting compound layer as a hotspot area. In other words, multiple hotspot areas of the cells can also be embedded in the potting compound layer at the same time, in particular both cell poles and the releasable degassing opening, which is also preferred since safety is maximized as a result. The cell poles or at least one of them can thus be embedded in the potting compound layer as at least one further hotspot area. This is also particularly advantageous since, in case of a thermal runaway of the relevant battery cell, a very strong heat development also takes place in the area of the cell poles. In other words, the cell poles of a damaged battery cell also become a hotspot area. By embedding them in the potting compound layer, especially these hotspot areas can be thermally decoupled very well from other cells and thermal spreading to other, above all adjacent battery cells can be delayed or even prevented much more efficiently.

It is particularly preferred that both the cell poles and the releasable degassing opening are simultaneously embedded in the potting compound layer, and a degassing channel is provided as described above. As a result, the gas can escape from a cell undergoing thermal runaway and can be discharged via the degassing channel, while the cell poles continue to be embedded in the potting compound layer and are therefore particularly well protected from contact with the outflowing gas. This is very advantageous as contact with the gas could cause voltage breakdowns and short circuits and contribute to thermal runaway of other cells and this could also result in ignition of the gas in the battery and thus a battery fire. This can thus advantageously be prevented.

According to a further advantageous embodiment of the invention, the battery cells are grouped into multiple cell groups, wherein the battery cells in the same cell group are at a smaller distance from one another, in particular perpendicular to the above-defined first direction, which points in the direction of the height of a respective battery cell, than the battery cells of different cell groups or than the distance of the cell groups from one another. In other words, by grouping the battery cells into cell groups, an additional clustering of the battery cells can take place. A thermal spread in the event of a thermal runaway from a battery cell in one cell group to an adjacent cell group is thus made even more difficult, even if there are no additional elements such as partition walls or separating layers or the like between the relevant cell groups. This makes thermal runaway even more difficult. In addition, the cell groups or at least some of the cell groups can also be spatially separated from one another by separating elements, for example partition walls of the battery housing. However, this does not have to be the case for all cell groups. In other words, it is preferred that no structural element, such as a partition wall or the like, is arranged at least between two of the cell groups. Such a clustering can, for example, also be implemented within one battery module of multiple battery modules comprised by the battery cell arrangement, or individual battery modules can also be provided by the respective cell groups. As a result of the clustering, improved thermal decoupling of the cell groups from one another can also be provided without the need to provide additional partition walls or insulation elements. Safety can thus be increased in a particularly space-saving manner and additional components can be saved.

Furthermore, the invention also relates to a motor vehicle having a battery cell arrangement according to the invention or one of its designs.

In addition, the invention also relates to a method for producing a battery cell arrangement for a motor vehicle, wherein multiple battery cells are provided, which each include two cell poles, a first side, a second side opposite to the first side, a height in the direction from the second side to the first side, and a releasable degassing opening for discharging gases from the relevant battery cell in case of a thermal runaway of the battery cell, wherein a respective battery cell includes at least one thermal hotspot area in case of a thermal runaway, which is provided by at least one of the cell poles and/or the degassing opening. Furthermore, a section of a respective battery cell is embedded in at least one potting compound layer in the direction of the height. In this case, the at least one thermal hotspot area is embedded in the potting compound layer, which is formed by a potting compound for thermally shielding the battery cells in case of a thermal runaway.

It can be provided that in the course of production the potting compound is introduced into the desired area in a liquid or viscous state and then cures or is actively cured.

The advantages mentioned for the battery cell arrangement according to the invention and its embodiments thus apply similarly to the motor vehicle according to the invention and the method according to the invention.

The motor vehicle according to the invention is preferably designed as an automobile, in particular as a passenger car or truck, or as a passenger bus or motorcycle.

The invention also includes refinements of the method according to the invention, which have features as have already been described in conjunction with the refinements of the battery cell arrangement according to the invention. For this reason, the corresponding refinements of the method according to the invention are not described again here.

The invention also comprises the combinations of the features of the described embodiments. The invention thus also comprises implementations that each include a combination of the features of several of the described embodiments, unless the embodiments were described as mutually exclusive.

### BRIEF DESCRIPTION OF THE FIGURES

Exemplary embodiments of the invention are described hereinafter. In the figures:

FIG. 1 shows a schematic and perspective representation of a battery arrangement according to an example not belonging to the invention;

FIG. 2 shows a schematic representation of the heat propagation in case of a thermal runaway of a battery cell of a battery arrangement according to FIG. 1;

FIG. 3 shows a schematic representation of a battery cell arrangement according to an exemplary embodiment of the invention.

### DETAILED DESCRIPTION

The exemplary embodiments explained hereinafter are preferred embodiments of the invention. In the exemplary embodiments, the described components of the embodiments each represent individual features of the invention to be considered independently of one another, which each also refine the invention independently of one another. Therefore, the disclosure is also intended to comprise combinations of the features of the embodiments other than those represented. Furthermore, the described embodiments can also be supplemented by further ones of the above-described features of the invention.

In the figures, same reference numerals respectively designate elements that have the same function.

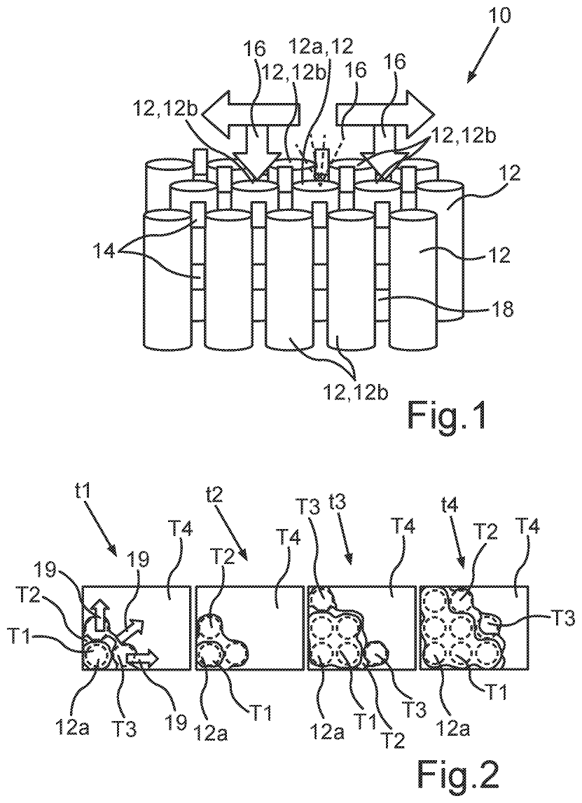

FIG. 1 shows a battery arrangement 10 according to an example not belonging to the invention. The battery arrangement includes multiple battery cells 12 designed as round cells. These are each arranged at a distance from one another, which may be effectuated by spacers 14 which are arranged between the cells 12. FIG. 1 shows in particular a situation in which a battery cell 12a is undergoing thermal runaway. Battery modules, such as the battery arrangement 10 shown here, are typically constructed by means of many individual cells 12. In case of overheating or outgassing of an individual cell 12a, as shown here, a chain reaction is then triggered accordingly, in which the resulting heat or the gas 16 escapes upwards from the cell 12a. The gas 16 above the cells 12 correspondingly also contaminates the neighboring cells 12b from above. Solely electrical and/or thermal insulation of the adjacent cells 12 in the intermediate spaces 18 would therefore not be sufficient at this point, since this could not prevent the illustrated thermal spread to the adjacent cells 12 by the escaping gas 16. The thermal spread to adjacent cells 12 is again illustrated schematically in FIG. 2.

FIG. 2 again schematically shows such a thermal spread in a sequence of individual time steps t1, t2, t3, t4, which follow one another in time. In the first time step t1, a first battery cell 12a, as previously described in FIG. 1, thermally runs away. As a result, a strong heat development, which is illustrated by the arrows 19, starts from this battery cell 12a undergoing thermal runaway. Furthermore, the thermal spread is illustrated in the individual illustrations for the respective time steps t1, t2, t3, t4 based on a respective thermal image recording, in which individual areas represent different temperature ranges. The temperature ranges having the highest temperature are denoted by T1, the areas of a second, lower temperature are denoted by T2, the areas having a third, lower temperature than the second temperature T2 are denoted by T3, and the areas having the lowest temperature are denoted by T4. As can be seen in the time sequence, the temperature spreads increasingly from adjacent cell 12 to adjacent cell 12, starting from the cell 12a undergoing thermal runaway. Accordingly, this also results in heating of the adjacent cells 12, which in turn results in an exothermic reaction of these adjacent cells 12 and accordingly to a thermal runaway of these adjacent cells 12, and this in turn increases the reaction rate. Thermal runaway of the entire battery arrangement 10 occurs. This principle applies not only to round cells, as shown here, but in general also to pouch cells and prismatic cells.

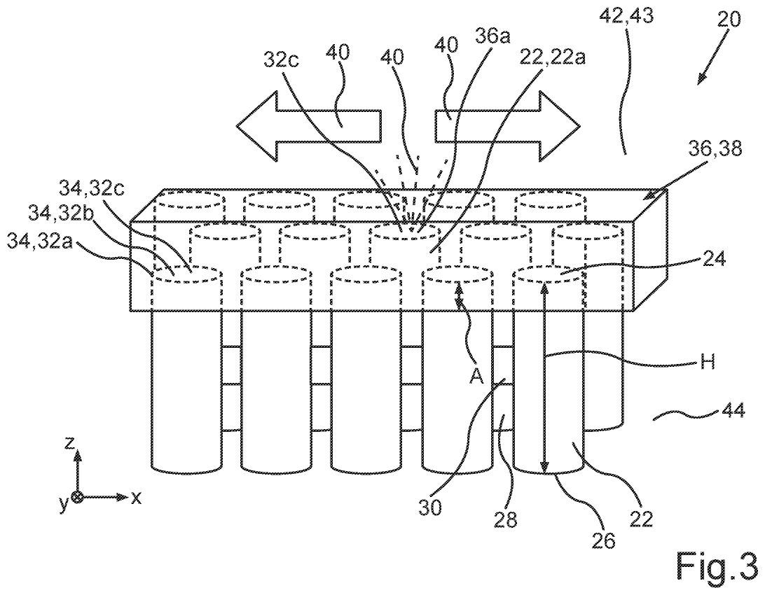

FIG. 3 shows a schematic representation of a battery cell arrangement 20 according to an exemplary embodiment of the invention. In this case, the battery cell arrangement 20 includes multiple battery cells 22. A respective battery cell includes a first side 24 and an opposite second side 26. These two sides 24, 26 are in particular opposite to one another with respect to a first direction, which is defined by the z-direction shown here. Furthermore, a height H of a respective battery cell 22 is also defined in this z-direction from the second side 26 to the first side 24. For reasons of clarity, only one battery cell 22 and its first and second sides 24, 26 and its height H are provided with a reference sign. The battery cells 22 are designed as round cells in this example, but can also be designed as pouch cells or prismatic cells in the same way. Furthermore, the cells 22 can be arranged on a common carrier, which is not shown in the present case, however. The cells 22 are then arranged on the carrier so that their respective second sides 26 face toward the carrier and their respective first sides 24 face away from the carrier. Furthermore, the cells 22 can be arranged in such a way that intermediate spaces 28 are formed between them. For reasons of clarity, only one such intermediate space 28 is also provided with a reference sign in this case. In such an intermediate space 28, spacers 30 can in turn optionally be arranged. These can also be provided by a spacer grid or the like. Furthermore, each cell 22 includes two cell poles 32a, 32b. A first of these cell poles 32a, 32b can be arranged in an edge area of the first side 24, and the other of the two poles 32a, 32b is also arranged on this first side 24, but at a distance from the edge area. The poles 32a, 32b can be provided, for example, via tap tabs or the like, but these are not explicitly shown in the present case.

In addition, a respective cell 22 comprises a releasable degassing opening 32c, which is also arranged on the first side 24 but at a different position from the poles 32a, 32b. This releasable degassing opening 32c can be formed, for example, as a predetermined breaking point in the first side 24 of the relevant battery cell 22. In case of a thermal runaway of a battery cell 12, these components, namely the cell poles 32a, 32b and the releasable degassing opening 32c, represent hotspot areas 34. Precisely in these hotspot areas 34, the temperature development of the cell 22 undergoing thermal runaway is particularly strong. In case of a thermal runaway, these hotspot areas 34 can also merge into a common hotspot area of the relevant cell 22.

The battery cell arrangement 20 now advantageously includes a potting compound layer 36 made of a potting compound 38, which embeds at least one of the hotspot areas 34 described and in the present example embeds all three hotspot areas 34, namely the two cell poles 32a, 32b and the releasable degassing opening 32c. This can be implemented particularly easily in the present case, since these hotspot areas 34 are all arranged on the same side of the battery cell 22, namely on the first side 24 in the present case. Accordingly, the complete first side 24 of a respective battery cell 22, and also a lateral section, is embedded in the potting compound 38. To put it more precisely, an entire section A of a respective cell 22 will be embedded or is embedded in this potting compound layer 36 in the direction of its height H. In this example, this section A represents an end area of a respective cell 22, which comprises the first side 24.

A thermally very stable and electrically insulating as well as thermally insulating material is preferably used as the potting compound 38. It is above all advantageous if the potting compound 38 also has ceramizing properties, i.e., it becomes a ceramic when a specific limiting temperature is exceeded. Ceramizing properties of the potting compound 38 thus insulate even at high temperatures. By providing such a potting compound layer 36, it can thus advantageously be implemented that the cell contacts 32a, 32b are insulated by means of the potting compound 38 from the gas flow 40 of the outgassing cell 22a, both thermally and electrically.

A cell 22a undergoing thermal runaway is again shown in this battery cell arrangement 20 in FIG. 3 as an example. In the situation shown, its releasable degassing opening 32c is already open, and gas 40 escapes from this released degassing opening 32c of the cell 22. The layer thickness of the potting compound layer 36 in the area above this opening 32c is made sufficiently thin so that the escaping gas 40 can penetrate the potting compound layer 36 in this potting compound area 36a without problems. The escaping gas 40 thus enters a sub-space 42, for example still within a battery housing, which is also not shown here, wherein this sub-space 42 is spatially and fluidically separated from a further sub-space 44 by the potting compound layer 36. This first sub-space 42 can accordingly function as part of a degassing channel through which the escaping gas 40 is discharged from the battery cell arrangement 20 and in particular from the battery and the motor vehicle in which the battery cell arrangement 20 is used. The gas 40 can therefore escape outwards from the cell 22 in the z-direction and does not thermally contaminate any adjacent cell 22 in the process. The potting compound layer 36 thus implements an insulating cover in the x, y, and z direction.

All of the heat generated thus remains at the affected cell 36a or exits through the outlet opening 32c to the outside and is conducted to the outside via the degassing channel 43 implemented in the sub-space 42. A chain reaction or propagation can be prevented by the thermal decoupling from other cells 22. There is therefore no damage and outgas sing of the adjacent cells 22 or the entire battery or explosion. It may even be possible to repair the battery after such a thermal event of a cell 22 due to the strong localization of the damage.

As a further advantage and side effect, additional spacers in the upper area of the cells 22 can also be dispensed with, since this spacer function can additionally also be implemented by the potting compound layer 36, at least in the upper area of the cells 22. It is thus advantageously also possible to dispense with the use of plastic or metal spacers as an example of such spacers in the upper area of the relevant cell 22, since the cells 22 are supported here by the potting compound 38. The terms “upper” and “lower” and directional specifications derived therefrom generally refer to the preferred intended installation position of the battery cell arrangement 20 in a motor vehicle. However, it is also conceivable that, for example, the potting compound layer 36 embeds a lower section of the cells 22 and instead cooling of the cells 22 is implemented via a plate above the cells 22. Any other installation positions are correspondingly conceivable.

Overall, the examples show how no-propagation battery modules can be provided by the invention, i.e., battery modules or an entire HV battery, in which thermal propagation across all cells can be prevented by providing the described potting compound layer in case of thermal runaway of one cell.

1. A battery cell arrangement for a motor vehicle, comprising:
multiple battery cells, each of which includes two cell poles, a first side, a second side opposite to the first side, a height in the direction from the second side to the first side and a releasable degassing opening for discharging gases from the relevant battery cell in case of a thermal runaway of the battery cell,
wherein in case of a thermal runaway, a respective battery cell includes at least one thermal hotspot area, which is provided by at least one of the cell poles and/or the degassing opening,
wherein the battery cell arrangement includes at least one potting compound layer, in which a section of a respective battery cell is embedded in the direction of the height,
wherein the at least one thermal hotspot area is embedded in the potting compound layer, which is formed by a potting compound for thermally shielding the battery cells from one another in case of a thermal runaway.

2. The battery cell arrangement as claimed in claim 1, wherein the potting compound is electrically and/or thermally insulating.

3. The battery cell arrangement as claimed in claim 1, wherein the potting compound is ceramizing from a predetermined temperature, in particular above 100° C., and in particular comprises ceramic particles embedded in a matrix.

4. The battery cell arrangement as claimed in claim 1, wherein the at least one hotspot area comprises the releasable degassing opening of a respective battery cell.

5. The battery cell arrangement as claimed in claim 1, wherein the releasable degassing opening is arranged on the first side, wherein the first side is embedded in the potting compound layer, in particular wherein the second side faces toward a carrier on which the battery cells are arranged.

6. The battery cell arrangement as claimed in claim 1, wherein the releasable degassing opening of a respective battery cell is embedded in the potting compound layer in such a way that in case of a thermal runaway of the relevant battery cell, a potting compound area of the potting compound layer covering the releasable degassing opening is penetrated by the gas escaping from the associated degassing opening.

7. The battery cell arrangement as claimed in claim 6, wherein a degassing channel for discharging the gas penetrating the potting compound area is arranged on a side of the potting compound layer facing away from the battery cells, in particular wherein the degassing channel adjoins the potting compound layer.

8. The battery cell arrangement as claimed in claim 1, wherein one of the cell poles, preferably both of the cell poles, is/are embedded in the potting compound layer as the at least one hotspot area.

9. The battery cell arrangement as claimed in claim 1, wherein the battery cells are grouped into multiple cell groups, wherein the battery cells in the same cell group are at a smaller distance from one another than the battery cells in different cell groups.

10. A method for producing a battery cell arrangement for a motor vehicle, comprising the following steps:
providing multiple battery cells, which each include two cell poles, a first side, a second side opposite to the first side, a height in the direction from the second side to the first side, and a releasable degassing opening for discharging gases from the relevant battery cell in case of a thermal runaway of the battery cell, wherein in case of a thermal runaway, a respective battery cell includes at least one thermal hotspot area, which is provided by at least one of the cell poles and/or the degassing opening;
embedding a section of a respective battery cell in the direction of the height in at least one potting compound layer;
wherein the at least one thermal hotspot area is embedded in the potting compound layer, which is formed by a potting compound for thermally shielding the battery cells in case of a thermal runaway.

11. The battery cell arrangement as claimed in claim 2, wherein the potting compound is ceramizing from a predetermined temperature, in particular above 100° C., and in particular comprises ceramic particles embedded in a matrix.

12. The battery cell arrangement as claimed in claim 3, wherein the at least one hotspot area comprises the releasable degassing opening of a respective battery cell.

13. The battery cell arrangement as claimed in claim 3, wherein the at least one hotspot area comprises the releasable degassing opening of a respective battery cell.

14. The battery cell arrangement as claimed in claim 2, wherein the releasable degassing opening is arranged on the first side, wherein the first side is embedded in the potting compound layer, in particular wherein the second side faces toward a carrier on which the battery cells are arranged.

15. The battery cell arrangement as claimed in claim 3, wherein the releasable degassing opening is arranged on the first side, wherein the first side is embedded in the potting compound layer, in particular wherein the second side faces toward a carrier on which the battery cells are arranged.

16. The battery cell arrangement as claimed in claim 4, wherein the releasable degassing opening is arranged on the first side, wherein the first side is embedded in the potting compound layer, in particular wherein the second side faces toward a carrier on which the battery cells are arranged.

17. The battery cell arrangement as claimed in claim 2, wherein the releasable degassing opening of a respective battery cell is embedded in the potting compound layer in such a way that in case of a thermal runaway of the relevant battery cell, a potting compound area of the potting compound layer covering the releasable degassing opening is penetrated by the gas escaping from the associated degassing opening.

18. The battery cell arrangement as claimed in claim 3, wherein the releasable degassing opening of a respective battery cell is embedded in the potting compound layer in such a way that in case of a thermal runaway of the relevant battery cell, a potting compound area of the potting compound layer covering the releasable degassing opening is penetrated by the gas escaping from the associated degassing opening.

19. The battery cell arrangement as claimed in claim 4, wherein the releasable degassing opening of a respective battery cell is embedded in the potting compound layer in such a way that in case of a thermal runaway of the relevant battery cell, a potting compound area of the potting compound layer covering the releasable degassing opening is penetrated by the gas escaping from the associated degassing opening.

20. The battery cell arrangement as claimed in claim 5, wherein the releasable degassing opening of a respective battery cell is embedded in the potting compound layer in such a way that in case of a thermal runaway of the relevant battery cell, a potting compound area of the potting compound layer covering the releasable degassing opening is penetrated by the gas escaping from the associated degassing opening.
